(19) United States
(12) Patent Application Publication
(10) Pub. No.: US 2013/0166563 A1
(43) Pub. Date: Jun. 27, 2013

(54) Integration of Text Analysis and Search Functionality

(71) Applicants: Thomas Mueller, Wiesloch (DE); Florian Kresser, Lobbach (DE); Daniel Buchmann, Eggenstein (DE); Hans-Martin Ludwig, Sandhausen (DE); Thomas Finke, Hockenheim (DE); Karl Fuerst, Wiesloch (DE)

(72) Inventors: Thomas Mueller, Wiesloch (DE); Florian Kresser, Lobbach (DE); Daniel Buchmann, Eggenstein (DE); Hans-Martin Ludwig, Sandhausen (DE); Thomas Finke, Hockenheim (DE); Karl Fuerst, Wiesloch (DE)

(73) Assignee: SAP AG, Walldorf (DE)

(21) Appl. No.: 13/333,155

(22) Filed: Dec. 21, 2011

(51) Int. Cl. G06F 17/30

(52) U.S. Cl. 707/740; 707/E17.058

(57) ABSTRACT

Example systems and methods of integrating text analysis and search functionality are presented. In one example, a plurality of documents, as well as search information comprising search terms for a search category, are accessed. Each of the documents that include at least one of the search terms is identified. The identified documents are analyzed to determine those of the identified documents that are logically associated with the search category. Each of the documents determined to be logically associated with the search category are tagged with the search category.

### FIELD

The present disclosure relates generally to search functionality, and

more specifically, to the integration of text analysis and searching of documents and other data objects.

### BACKGROUND

Text analysis tools are often used to generate structured data (such as, for example, spreadsheets and structured business data employable in enterprise resource planning (ERP) systems) from unstructured data (such as word processing files, displayable electronic documents, and the like). While some worthwhile results from text analysis, such as the identification of key terms or phrases, does not often require any additional input beyond the document or text being analyzed, other results, such as the identification of entity instances (for example, dates, locations, names, and so on) are typically based on entity-specific rules which are made available to the text analysis function in addition to the documents being analyzed. In many cases, structured data is easier for both users and computer-based applications to utilize, given the added organization and context provided in structured data over its unstructured counterpart.

Search tools, generally speaking, facilitate the discovery and subsequent access of documents, business data objects, and other types of structured and unstructured data that are logically related to a particular search query. The use of these search tools often relieves a user of the burden of perusing each potential document or data object, one by one, in order to find data of interest. Typically, the usefulness of search tools increases as the number of potential documents and other data objects increases.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an example system having a client-server architecture for an enterprise application platform capable of employing the systems and methods described herein;

FIG. 2 is a block diagram of example applications and modules employable in the enterprise application platform of FIG. 1;

FIG. 3 is a block diagram of example modules utilized in the enterprise application platform of FIG. 1 for systems and methods of integrating text analysis and search functionality;

FIG. 4 is a flow diagram of an example method of integrating text analysis and search functionality;

FIGS. 5A and 5B are a flow diagram representing data objects and associated method operations for integrating text analysis and search functionality;

FIG. 6 is a graphical representation of documents to be searched according to the example method operations of FIGS. 5A and 5B;

FIG. 7 is a graphical representation of search object types to be employed in the example method operations of FIGS. 5A and 5B;

FIG. 8 is a graphical representation of relevant documents and entity instance candidates generated according to the example method operations of FIGS. 5A and 5B;

FIG. 9 is a graphical representation of analyzed documents and identified entity instances generated according to the example method operations of FIGS. 5A and 5B;

FIG. 10 is a graphical representation of tagged documents generated according to the example method operations of FIGS. 5A and 5B;

FIG. 11 is a graphical representation of search results generated according to the example method operations of FIGS. 5A and 5B;

FIGS. 12A through 12C are block diagrams depicting various example techniques of tagging a data object, such as a document; and

FIG. 13 depicts a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

At least some of the embodiments described herein provide various techniques for integrating text analysis and search functions via the use of tagging data (or, alternatively, data “tags”) associated with one or more documents or data objects of interest.

As is described in greater detail below, in one example, a plurality of documents, as well as search information comprising search terms for a search category, are accessed. As employed throughout this disclosure, documents may refer to document files or other data objects that may be the subject of a search operation. Those of the plurality of documents that include at least one of the search terms are identified. The identified documents are further analyzed (for example, by way of text analysis) to determine those of the identified documents that are logically associated with the search category. Each of the determined documents are then tagged with the search category, possibly including one or more search terms that apply to the particular document being tagged. Presuming a search request is received that indicates the search category, the documents that are tagged with the search category may then be returned in response to the search request. As a result, text analysis results may be employed to enhance the results of a search request or query. Other aspects of the embodiments discussed herein may be ascertained from the following detailed description.

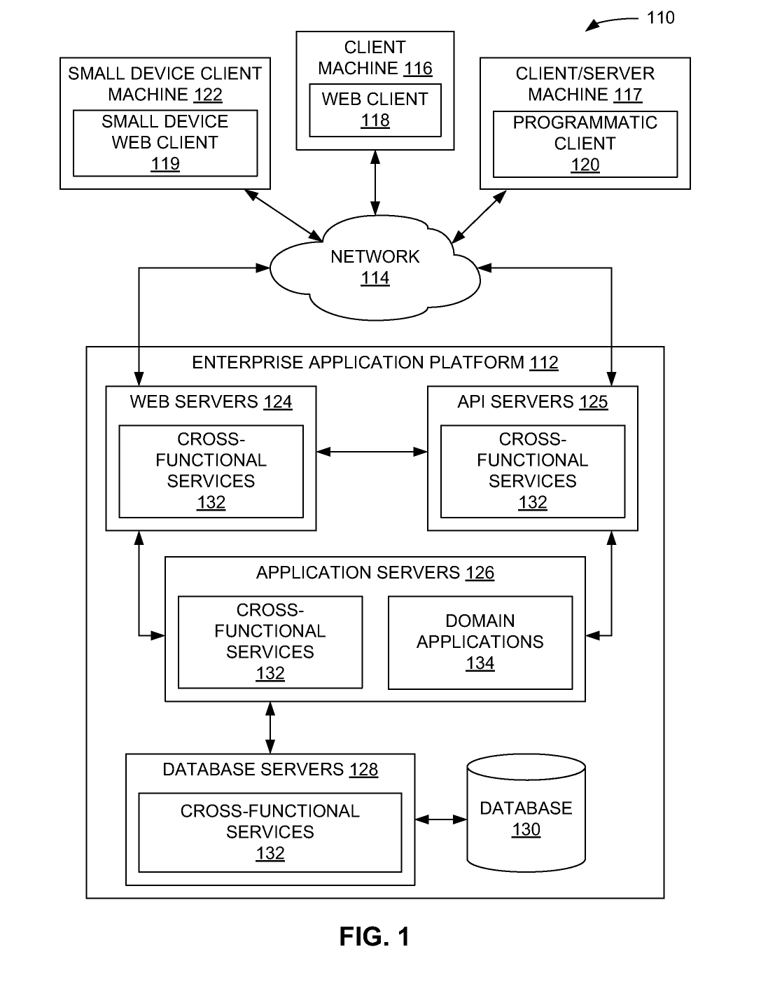

FIG. 1 is a network diagram depicting an example system 110, according to one exemplary embodiment, having a client-server architecture configured to perform the various methods described herein. A platform (e.g., machines and software), in the exemplary form of an enterprise application platform 112, provides server-side functionality via a network 114 (e.g., the Internet) to one or more clients. FIG. 1 illustrates, for example, a client machine 116 with a web client 118 (e.g., a browser, such as the INTERNET EXPLORER browser developed by Microsoft Corporation of Redmond, Washington State), a small device client machine 122 with a small device web client 119 (e.g., a browser without a script engine) and a client/server machine 117 with a programmatic client 120.

Turning specifically to the enterprise application platform 112, web servers 124, and Application Program Interface (API) servers 125 are coupled to, and provide web and programmatic interfaces to, application servers 126. The application servers 126 are, in turn, shown to be coupled to one or more database servers 128 that may facilitate access to one or more databases 130. The web servers 124, Application Program Interface (API) servers 125, application servers 126, and database servers 128 may host cross-functional services 132. The application servers 126 may further host domain applications 134.

The cross-functional services 132 may provide user services and processes that utilize the enterprise application platform 112. For example, the cross-functional services 132 may provide portal services (e.g., web services), database services, and connectivity to the domain applications 134 for users that operate the client machine 116, the client/server machine 117, and the small device client machine 122. In addition, the cross-functional services 132 may provide an environment for delivering enhancements to existing applications and for integrating third party and legacy applications with existing cross-functional services 132 and domain applications 134. Further, while the system 110 shown in FIG. 1 employs a client-server architecture, the present disclosure is of course not limited to such an architecture, and could equally well find application in a distributed, or peer-to-peer, architecture system.

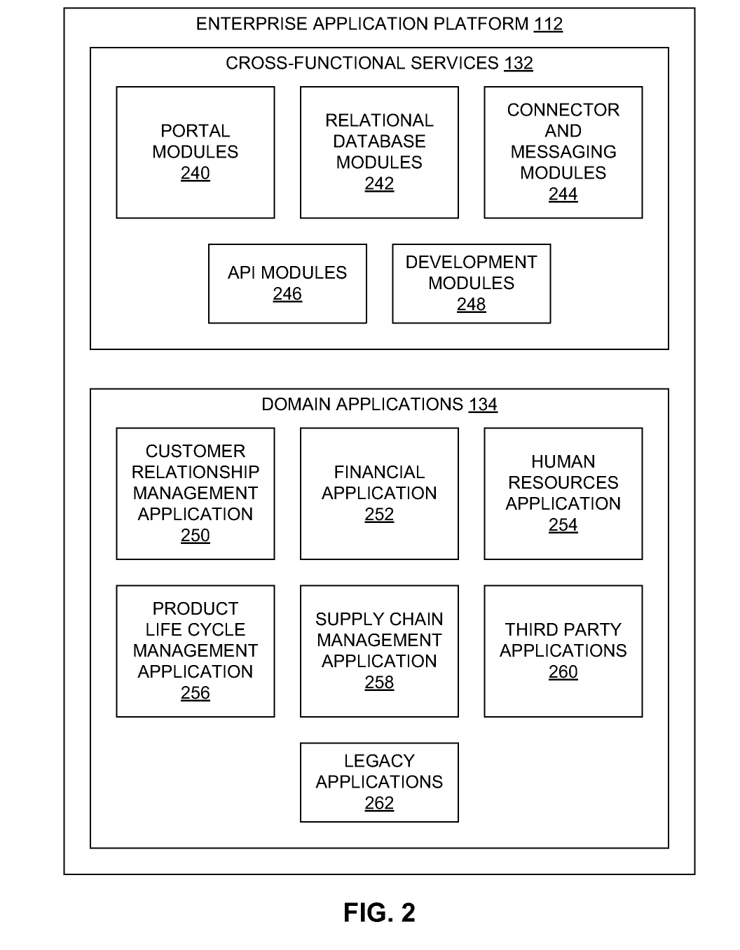

FIG. 2 is a block diagram illustrating example enterprise applications and services, such as those described herein, as embodied in the enterprise application platform 112, according to an exemplary embodiment. The enterprise application platform 112 includes cross-functional services 132 and domain applications 134. The cross-functional services 132 include portal modules 240, relational database modules 242, connector and messaging modules 244, Application Program Interface (API) modules 246, and development modules 248.

The portal modules 240 may enable a single point of access to other cross-functional services 132 and domain applications 134 for the client machine 116, the small device client machine 122, and the client/server machine 117 of FIG. 1. The portal modules 240 may be utilized to process, author, and maintain web pages that present content (e.g., user interface elements and navigational controls) to the user. In addition, the portal modules 240 may enable user roles, a construct that associates a role with a specialized environment that is utilized by a user to execute tasks, utilize services, and exchange information with other users and within a defined scope. For example, the role may determine the content that is available to the user and the activities that the user may perform. The portal modules 240 may include, in one implementation, a generation module, a communication module, a receiving module, and a regenerating module. In addition, the portal modules 240 may comply with web services standards and/or utilize a variety of Internet technologies, including, but not limited to, Java, J2EE, SAP's Advanced Business Application Programming Language (ABAP) and Web Dynpro, XML, JCA, JAAS, X.509, LDAP, WSDL, WSRR, SOAP, UDDI, and Microsoft .NET.

The relational database modules 242 may provide support services for access to the database 130 (FIG. 1) that includes a user interface library. The relational database modules 242 may provide support for object relational mapping, database independence, and distributed computing. The relational database modules 242 may be utilized to add, delete, update, and manage database elements. In addition, the relational database modules 242 may comply with database standards and/or utilize a variety of database technologies including, but not limited to, SQL, SQLDBC, Oracle, MySQL, Unicode, and JDBC.

The connector and messaging modules 244 may enable communication across different types of messaging systems that are utilized by the cross-functional services 132 and the domain applications 134 by providing a common messaging application processing interface. The connector and messaging modules 244 may enable asynchronous communication on the enterprise application platform 112.

The Application Program Interface (API) modules 246 may enable the development of service-based applications by exposing an interface to existing and new applications as services. Repositories may be included in the platform as a central place to find available services when building applications.

The development modules 248 may provide a development environment for the addition, integration, updating, and extension of software components on the enterprise application platform 112 without impacting existing cross-functional services 132 and domain applications 134.

Turning to the domain applications 134, the customer relationship management applications 250 may enable access to and facilitate collecting and storing of relevant personalized information from multiple data sources and business processes. Enterprise personnel that are tasked with developing a buyer into a long-term customer may utilize the customer relationship management applications 250 to provide assistance to the buyer throughout a customer engagement cycle.

Enterprise personnel may utilize the financial applications 252 and business processes to track and control financial transactions within the enterprise application platform 112. The financial applications 252 may facilitate the execution of operational, analytical, and collaborative tasks that are associated with financial management. Specifically, the financial applications 252 may enable the performance of tasks related to financial accountability, planning, forecasting, and managing the cost of finance.

The human resources applications 254 may be utilized by enterprise personal and business processes to manage, deploy, and track enterprise personnel. Specifically, the human resources applications 254 may enable the analysis of human resource issues and facilitate human resource decisions based on real-time information.

The product life cycle management applications 256 may enable the management of a product throughout the life cycle of the product. For example, the product life cycle management applications 256 may enable collaborative engineering, custom product development, project management, asset management, and quality management among business partners.

The supply chain management applications 258 may enable monitoring of performances that are observed in supply chains. The supply chain management applications 258 may facilitate adherence to production plans and on-time delivery of products and services.

The third-party applications 260, as well as legacy applications 262, may be integrated with domain applications 134 and utilize cross-functional services 132 on the enterprise application platform 112.

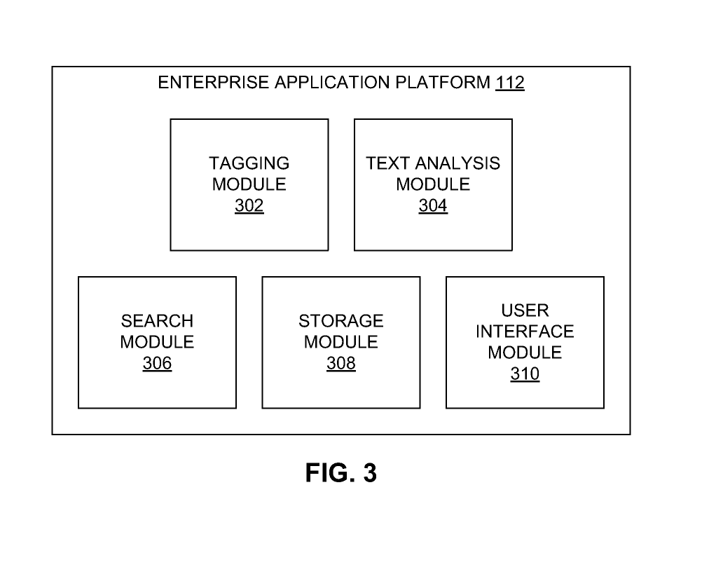

FIG. 3 is a block diagram of example modules employable in the enterprise application platform 112 of FIG. 1 for systems and methods of integrating text analysis and search functionality, such as by way of the tagging of data, as mentioned above. In the example of FIG. 3, the enterprise application platform 112 may include a tagging module 302, a text analysis module 304, a search module 306, a storage module 308, and/or a user interface module 310. In some implementations, one or more of these modules may be incorporated in other modules of the enterprise application platform 112. For example, the user interface module 310 may exist as one of the portal modules 240 (FIG. 2), while the storage module 308 may be one of the relational database modules 242 (also FIG. 2). Similarly, the text analysis module 304 and the search module 306 may be any of the domain applications 134 (FIGS. 1 and 2). In some examples, the tagging module 302 may be included in the relational database modules 242, a separate module of the cross-functional services 132, or elsewhere. Further, any of the modules 302 through 310 may be combined into fewer modules, or may be partitioned into a greater number of modules.

The tagging module 302 may perform any of the functions related to the tagging of documents and other data objects, including the generation, storage, maintenance, and/or use of the tagging data. In some examples, the tagging module 302 may be a combination of multiple modules, each of which provides separate functionality regarding the tagging of data objects. The operations of the tagging module 302 as they pertain to the text analysis and search functions presented herein are discussed below.

The text analysis module 304 and the search module 306 provide the text analysis and search capabilities described more fully below with respect to documents and other data objects. More specifically, the text analysis module 304 may analyze the text of documents to determine whether they are logically associated with a given search category or term, and communicate with the tagging module 302 to tag the documents with information to be used in a document search. A document is logically associated with a search category or term when at least a portion of the content of the document describes or addresses at least one aspect of the search category or term. Accordingly, the search module 306 employs the tagging to perform searches based on queries provided by users or other applications.

The storage module 308 may facilitate the storage and retrieval of both the documents and the tagging data. One example of the storage module 308 is a relational database, but any other type of storage facility capable of performing the various storage and retrieval functions compatible with the various examples discussed below may also serve as the storage module 308.

The user interface module 310 may provide an end user access to the search functionality described in greater detail below. In addition, the user interface module 310 may provide other types of users, such as programmers, content managers, administrators, and the like, access to the tagging data, documents, data objects, and related information described below in other examples.

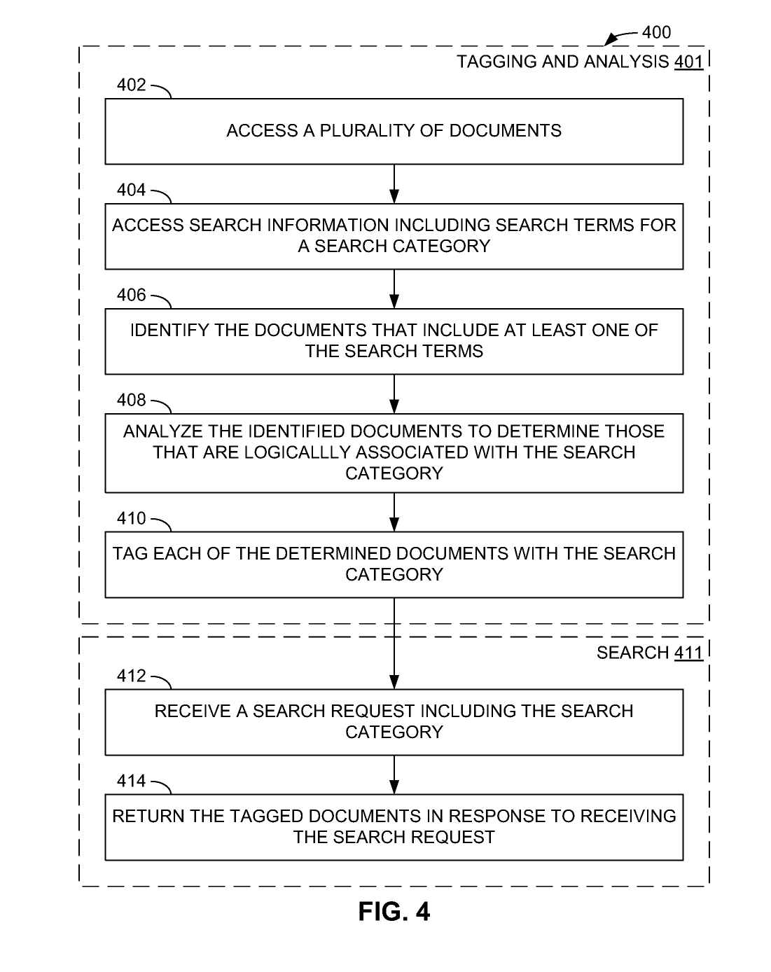

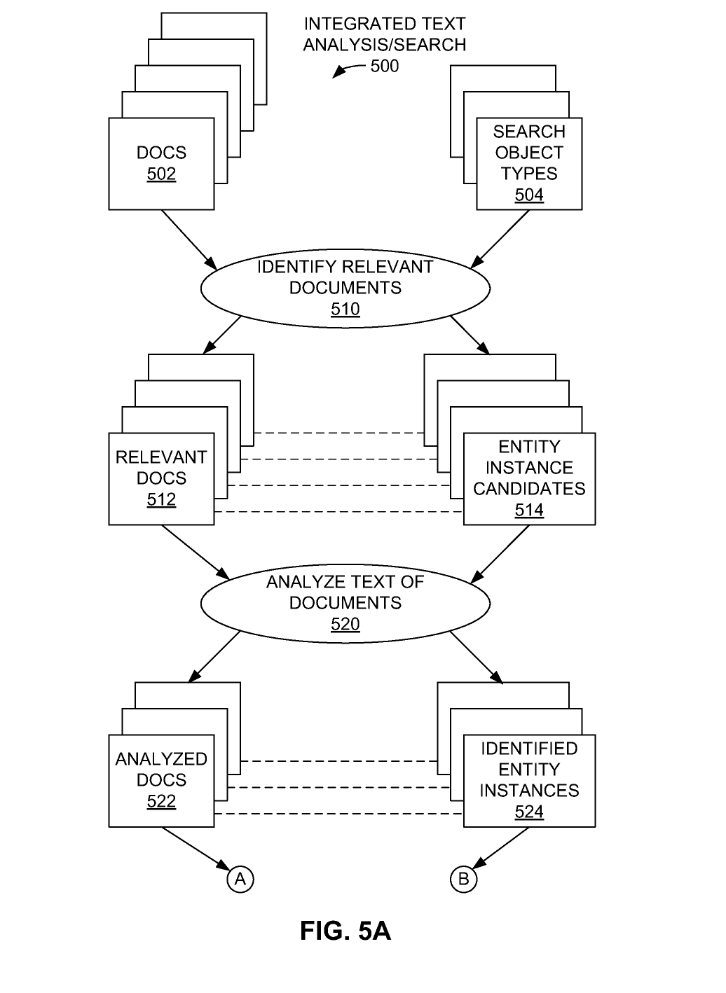

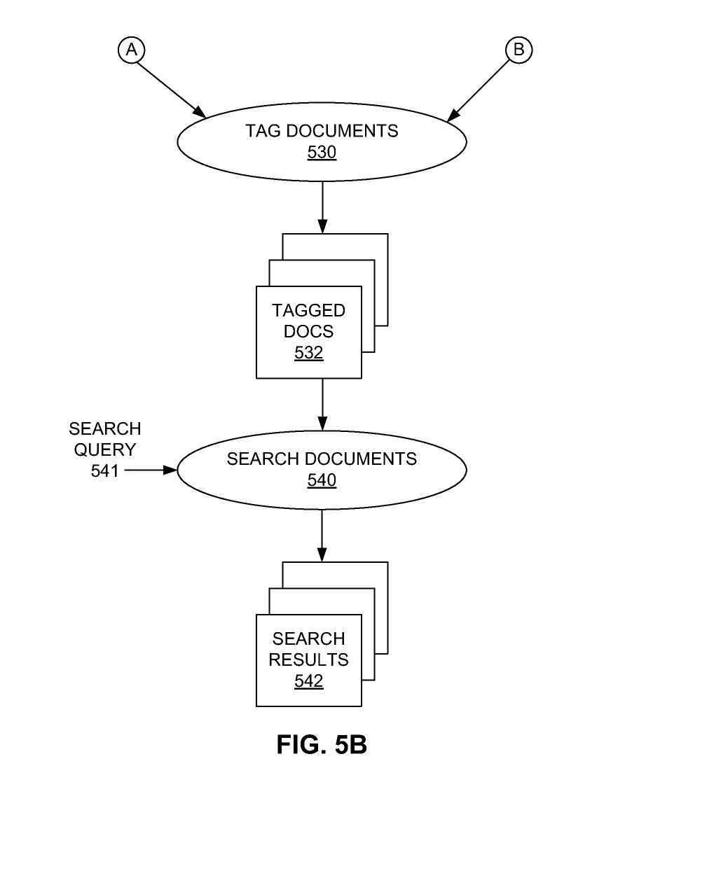

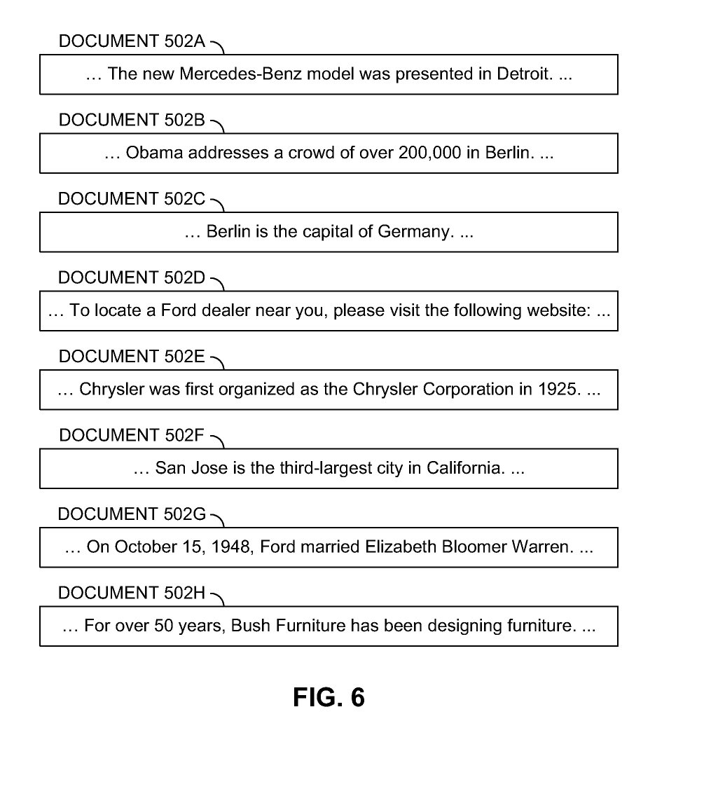

FIG. 4 illustrates an example method 400 of the integration of document or text analysis and search functionality by way of data tags. Thereafter, a more specific implementation of the method 400 is provided in FIGS. 5A and 5B, presented in combination with a particular example set of documents and related data depicted in FIGS. 6 through 11. While the description below uses documents as the targets of both the text analysis and search functions, other types of data objects may also be used in a similar manner. Such data objects may include, for example, structured data, unstructured data, or both. Generally, structured data may be data that is organized into multiple predefined fields of a record or file. Structured data may also include or be associated with metadata delineating and/or defining the various fields. Examples of structured data may include, but are not limited to, sales invoice records, purchase order records, accounting records, payroll records, database records, spreadsheet files, and other business-oriented data. Conversely, unstructured data is data that is not segmented into predefined fields. Typical examples of unstructured data may include, but are not limited to, word processing files, Portable Document Format (PDF) documents, and web documents (for example, HyperText Markup Language (HTML) files). In some examples, a file or document may include both structured and unstructured data portions.

As shown in FIG. 4, the method 400 is separated into a tagging and

analysis portion 401 and a search portion 411, showing generally how the two phases are integrated. In the method 400, a plurality of documents is accessed (operation 402). In some examples, a document may be any file or other data structure that includes text, including both structured and unstructured data, such as, for example, text files, word processing files, printable or displayable documents, spreadsheets, business records, and so on.

Search information is also accessed (operation 404). The search information may include or indicate a search category and associated search terms. In one example, the search category is a character string, word, term, phrase, or the like that may be subsequently used in a search request or query. In another example, the search terms may include specific examples or subcategories of the search category. For example, in examples discussed below in conjunction with FIGS. 5A through 11, a search category of “Car” may be associated with search terms “Mercedes-Benz,” “Ford,” “Toyota,” and so on.

Each of the documents that include at least one of the search terms may be identified (operation 406). Continuing with the example of a “Car” search category, those documents that contain the search terms associated with the “Car” category, such as the car companies, or “makes,” mentioned above, may be identified. In an implementation, the identified documents are considered to be candidates for a text analysis phase to follow, as words or phrases in a document, while appearing to be equivalent to the search terms, may not be synonymous with the search terms when taken in context with other portions of the document. In other examples, other types of search terms, such as the country of origin of each make, may be included in the search terms and used to identify the candidate documents.

The identified documents may then be analyzed to determine those documents that are logically associated with the search category (operation 408). In one example, the analysis may at least include text analysis that takes as input the documents to be analyzed, as well as entity or search term candidates to direct the analysis, examples of which are provided below. Those identified documents that are found to be logically associated with the search category are then tagged with the search category (operation 410). In addition, each of the tagged documents may be tagged with the particular search term found in, or otherwise associated with, the document.

As a result of the tagging and analysis functions 401, the data tags linked to, or associated with, the documents provides information that facilitates a more complete and focused search of the documents. To that end, in the search function 411, a search request including the search category may be received (operation 412). In response to the request, the tagged documents (i.e., those documents found to be logically associated with the search category) may be returned as results (operation 414).

The tagging and analysis portion 401 of the method 400 may be

initiated in a number of ways. For example, the reception of a search query (operation 412) may cause the tagging and analysis portion 401 to begin, especially if the tagging and analysis portion 401 has not been performed previously for a search category referenced in the search query. In some implementations, the tagging and analysis portion 401 may also be performed on documents that have been changed, added to the system, or deleted from the system so that the tagging data associated with the current documents remains up-to-date.

While the operations of the method 400 of FIG. 4 and other figures provided herein are shown in a specific order, other orders of operation, including possibly concurrent execution of at least portions of one or more operations, may be possible in some implementations.

FIGS. 5A and 5B, taken together, are a flow diagram of an example method 500 of integrating text analysis and search functionality using data tagging, including general representations of the associated documents and related data involved. Additionally, FIGS. 6 through 11 illustrate more specific examples of the documents and data objects involved in a particular application of the method 500. Thus, in the discussion to follow, FIGS. 6 through 11 are discussed in conjunction with FIGS. 5A and 5B to fully explain the embodiments presented.

In the method 500 of FIGS. 5A and 5B, a plurality of documents 502 and at least one search object type 504 (each serving as a search category or type with associated search terms) are received as input to a function that identifies relevant documents (operation 510) for subsequent text analysis. FIG. 6 is a graphical representation of eight such documents 502A through 502H. A pertinent portion of each document 502A-502H is presented to aid in understanding the operations illustrated in FIGS. 5A and 5B.

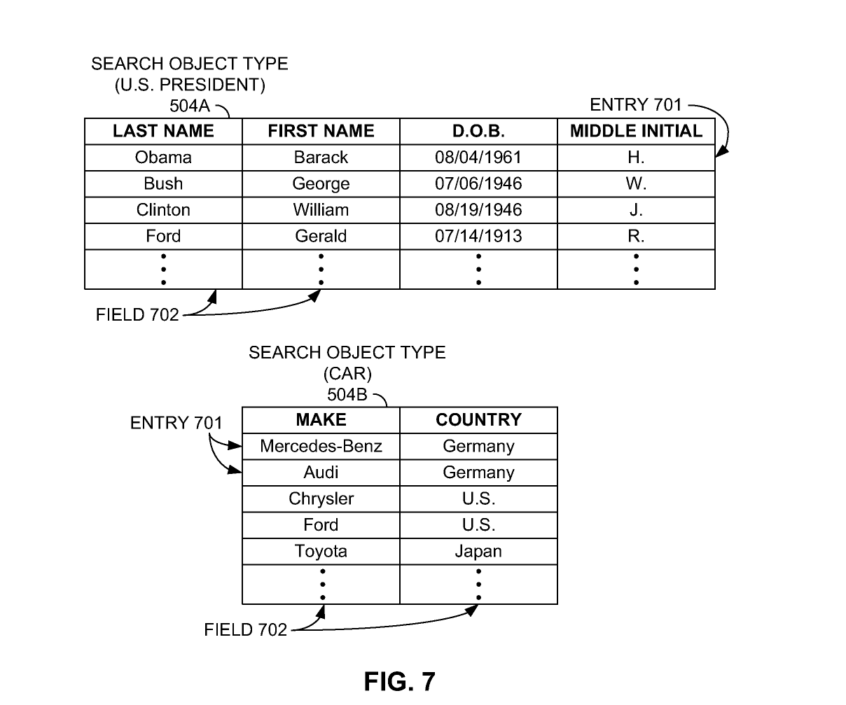

FIG. 7 is a graphical representation of two search object types 504A, 504B that are also used in the document identification operation 510. In the examples of FIG. 7, the search object types 504A, 504B are represented as data tables, but any other data structure capable of storing multiple entries 701, with each entry 701 having at least one field 702 descriptive of the entry 701, may be used in other implementations. The first search object type 504A is for a “U.S. President” search category that includes multiple entries 701, one for each President. Each entry 701 of the first search object type 504A includes a field 702 indicating a particular aspect or characteristic associated with entry 701. Each field 702 for an entry may be a search term for the search category, as described, in at least one example. As shown in FIG. 7, the fields 702 indicate a president's last name, first name, date of birth, and middle initial. More or fewer fields 702 for each entry 701 may be provided in other implementations. The second search object type 504B is for a “car” search category, with each entry 701 of the second search object type 504B representing a particular car manufacturer or make. As depicted in FIG. 7, each entry 701 includes a make name and a country associated with the manufacturer. Generally, each of the search object types 504A, 504B may include any number of entries 701 and fields 702, depending on the particular search category involved.

Given the search object types 504A, 504B, those of the documents 502A-502H that are relevant for further text analysis are identified (operation 510 of FIG. 5A). In the particular example described herein, the values in the first field 702 of each search object type 504A, 504B (i.e., the “last name” field 702 of the first search object type 504A and the “make” field 702 of the second search object type 504B) are employed to identify candidate documents 504 for text analysis. In reviewing the documents 502A-502H of FIG. 6 for the “U.S. President” search category, the second document 502B includes the term “Obama,” the fourth document 502D and the seventh document 502G each include the word “Ford,” and the eighth document 502H includes the term “Bush.” Each of these terms is referred to in one of the first fields 702 of the first search object type 504A. Similarly, regarding the second search object type 504B, the first document 502A includes a reference to “Mercedes-Benz,” the fourth document 502D and the seventh document 502G include the term “Ford,” (also appearing in the first field 702 of the first search object type 504A, as mentioned above), and the fifth document 502E includes at least two references to the word “Chrysler.” As each of these terms appears in the first field 702 of the second search object type 504B, the identification operation 510 (FIG. 5A) will regard each of these documents 502 as candidate documents 512 with respect to their corresponding search categories.

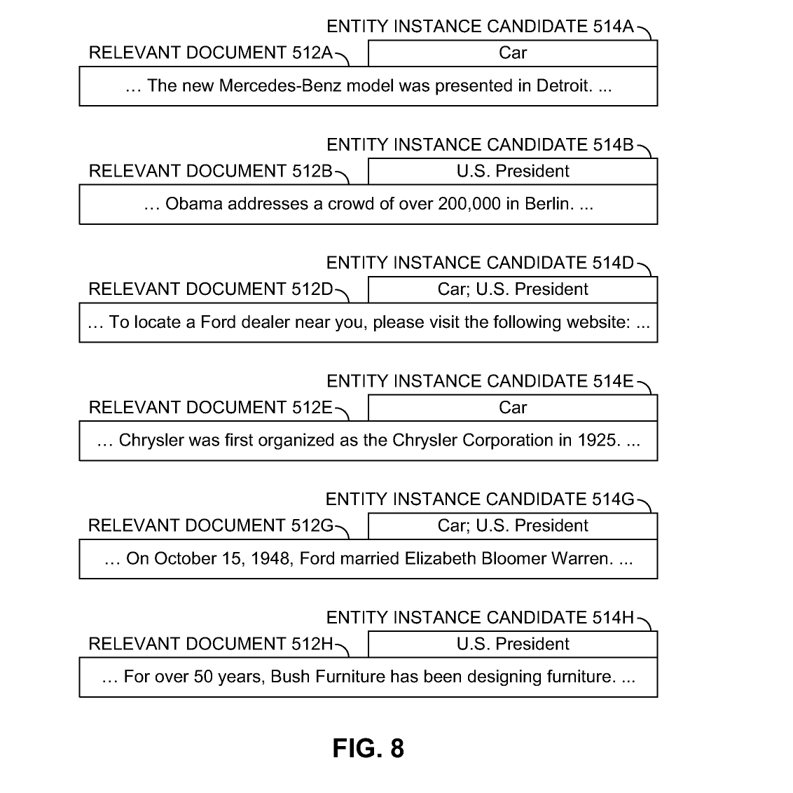

The resulting relevant documents 512, as described above, are depicted in FIG. 8. More particularly, relevant documents 512A, 512D, 512E, and 512G are associated with the category “Car,” while relevant documents 512B, 512D, 512G, and 512H correspond to the category “U.S. Presidents.” Each of these relevant documents 512A, 512B, 512D, 512E, 512G, and 512H is identified with a corresponding entity instance candidate 514A, 514B, 514D, 514E, 514G, and 514H, each of which explicitly indicates which category (“Car” and/or “U.S. President”) applies to the corresponding relevant document 512A, 512B, 512D, 512E, 512G, and 512H. As neither the third document 512C nor the sixth document 512F are identified with either the first search object type 504A or the second search object type 504B based on the “make” or “last name” fields 702 (FIG. 7) or search terms, neither appears as a relevant document in FIG. 8. In an alternate embodiment, the identifying operation 510 may employ other fields, such as, for example, the “country” field 702 for the second search object type 504B. In that case, the identifying operation 510 may identify the third document 502C as relevant for its use of the term “Germany.”

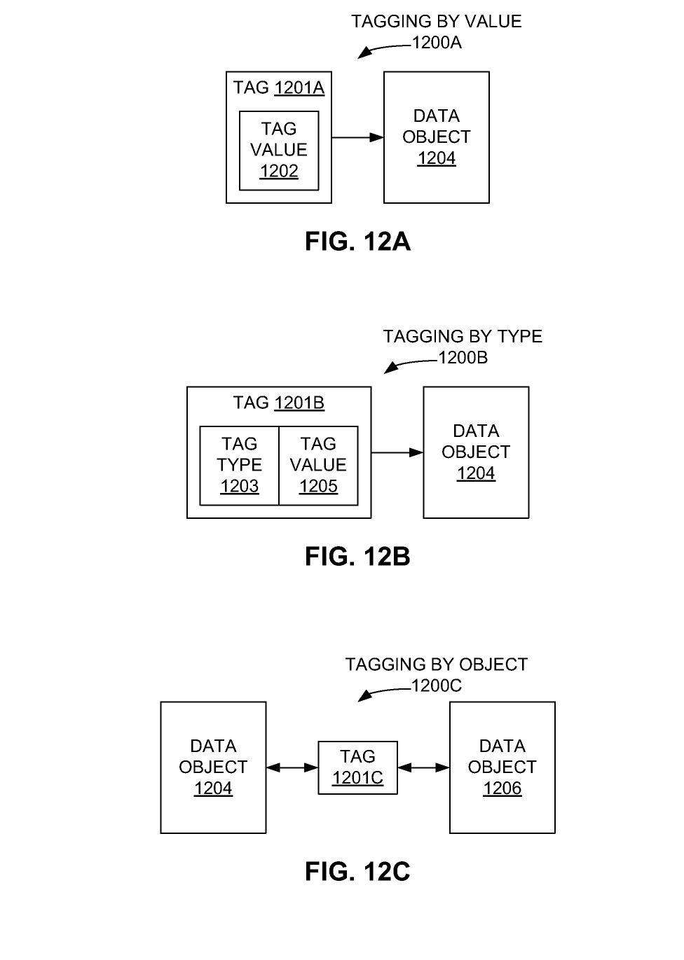

In one example, the entity instance candidates 514 may be data tags that are linked or otherwise associated with their respective relevant documents 512. Examples of the types of data tags that may be employed are provided in FIG. 12.

The identification function 510 may be provided automatically in the tagging module 302 (FIG. 3) in one example based on the presence or availability of the documents 502 and search object types 504. In another implementation, one or more users may be responsible for performing the identification function 510.

The relevant documents 512 and the entity instance candidates 514 are forwarded to a text analysis function (operation 520 of FIG. 5A). In one embodiment, the text analysis function 520 analyzes the relevant documents 512 to determine whether each relevant document 512 is logically associated with the search category indicated in its entity instance candidate 514. In at least one implementation, this determination may be made by comparing at least one of the search terms found in each relevant documents 512 with other portions of the same document to determine if the search term is associated with the search category.

For example, regarding the search category of “Car,” the term “Mercedes-Benz” appearing in the relevant document 512A may, in and of itself, indicate that a car is being referred to or discussed, and the presence of the words “model” and “Detroit” may provide further verification. In the relevant document 512E, the mere existence of the word “Chrysler” may be enough to indicate that a car is being discussed therein, emphasized by the inclusion of the phrase “Chrysler Corporation” in the document 512E.

As to the search category “U.S. President,” the presence of the term “Obama” in the relevant document 512B, possibly in conjunction with a reference to a crowd in Berlin, is likely sufficient to indicate that a U.S. president is being referenced. On the other hand, text analysis may determine that the appearance of the word “Bush” in conjunction with the term “Furniture” indicates that a furniture business is being discussed, as opposed to a U.S. president.

On the other hand, the presence of the term “Ford” in both relevant documents 512D and 512G is applicable at first glance to both the “Car” and “U.S. President” search categories. However, text analysis may determine that the presence of the term “dealer” adjacent to the word “Ford” in relevant document 514D may indicate that “Ford” refers to the carmaker, and that relevant document 514D is thus logically associated to the “Car” search category, and not the “U.S. President” category. Oppositely, the use of the term “Ford” in relation to a marriage in 1948, as the term appears in relevant document 512G, indicates that the relevant document 512G is more likely to be logically associated with the “U.S. President” category than the “Car” category.

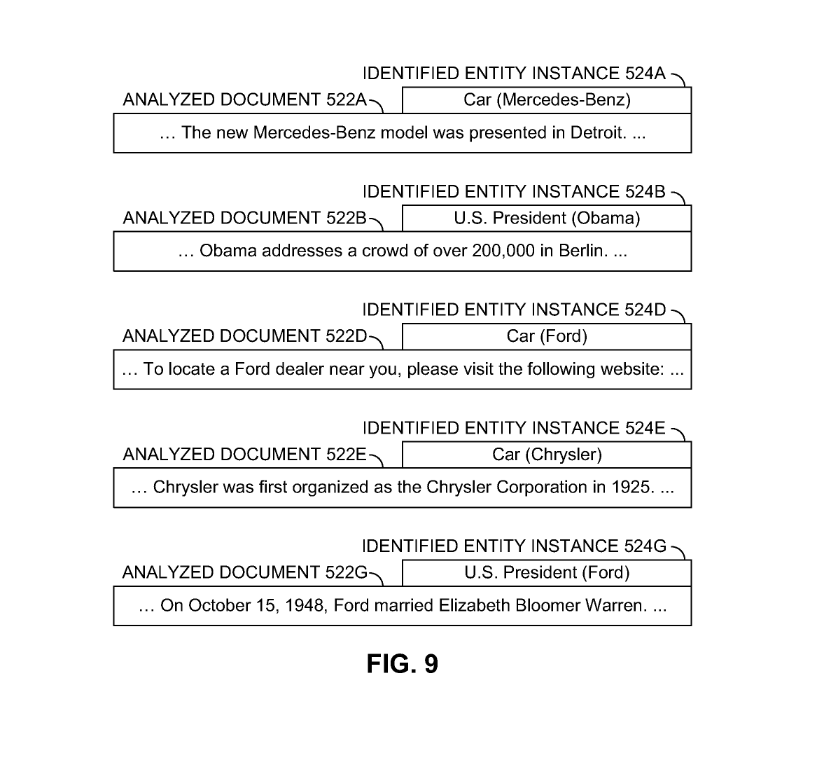

As a result of the text analysis operation 520, performed in at least one example by the text analysis module 304 (FIG. 3), five of the six relevant documents 512A, 512B, 512D, 512E, and 512G are found to be logically associated with at least one of the search categories indicated by the search object types 504. These relevant documents may then be forwarded as analyzed documents 522A, 522B, 522D, 522E, and 522G, as shown in FIG. 9, to a document tagging function 530, as depicted in FIG. 5B. Also, the text analysis operation 520 may generate an identified entity instance 524 for each of the analyzed documents 522 for the document tagging function 530. Depending on the example, each of the identified entity instances 524 indicates at least the search category, possibly along with the particular search term or field associated with the corresponding analyzed document 522. As shown in FIG. 9, in accordance with the process described above, the identified entity instance 524A indicates a search category of “Car” and a related search term of “Mercedes-Benz.” Similarly, identified entity instance 524B indicates a “U.S. President,” specifically Obama, the identified entity instance 524D refers to a “Car,” more accurately a “Ford,” the identified entity instance 524E refers to a different “Car,” a “Chrysler,” while the identified entity instance 524G is directed to a “U.S President,” “Ford.”

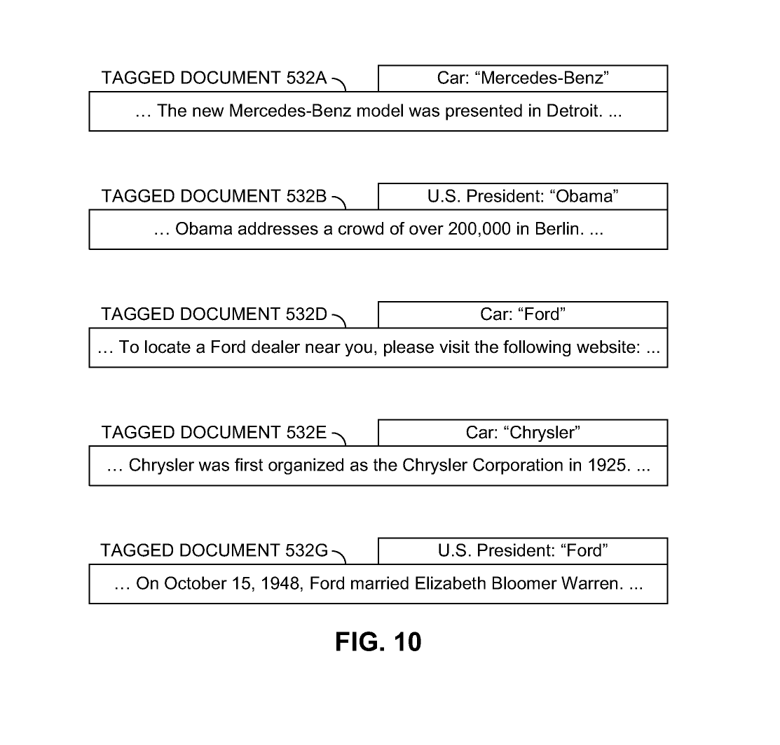

In response to receiving the analyzed documents 522 and their corresponding identified entity instances 524, the tagging function 530 may tag each of the analyzed documents with the information in the identified entity instances 524, resulting in tagged documents 532A, 532B, 532D, 532E, and 532G illustrated in FIG. 10. As shown, each of the tagged documents 532 is tagged with a tag “type” (“Car” or “U.S. President”), possibly along with a tag value associated with that type (such as “Mercedes-Benz or “Obama”). In at least one implementation, the tagging module 302 (FIG. 3) performs the tagging function 530. FIG. 12 depicts several different possible implementations of the tagging information for each of the tagged documents 532.

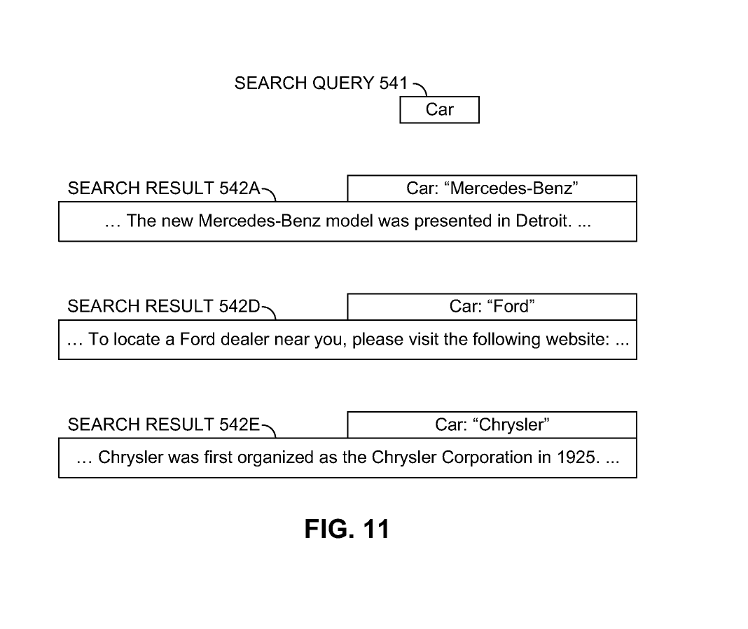

As shown in FIG. 5B, a search document function 540, in response to a search request or query 541, may access the tagged documents 532 and return one or more search results 542 in response to the query 541. In at least one example, the search results 542 are those tagged documents 532 which correspond to the query 541. The search module 306 (FIG. 3) provides the search document function 540 in one implementation. In the example of FIG. 11, in which the query 541 is “Car,” the search document function 540 returns those documents which are tagged with the search category “Car,” which in the present example are search result 542A (associated with a Mercedes-Benz), search result 542D (associated with a Ford), and search result 542E (associated with a Chrysler). In another example, if a search query included “U.S. Presidents,” tagged documents 532B and 532G, referring to Presidents Obama and Ford, respectively, may be returned in response. In one implementation, the query 541 and the search results 542 are transferred to and from a user via the user interface module 310 (FIG. 3).

In reference to FIGS. 6-11, in one example, at least some of the documents 502, 512, 522, 532, the related data structures, 504, 514, 524 (including data tags), and the search results 542 may be stored in the storage module 308 (FIG. 3).

As a result of the embodiments described above, a more accurate and focused search functionality may be provided due to the text analysis and associated tagging functions integrated with the search. For example, each of the search results 542 of FIG. 11 include references to cars, and thus are applicable to the search query 541 of “Car” without actually including the word “car” in the documents 502. Further, a reference to President Ford in document 502G is not returned, as the method 500 does not mistake the document 502G as being directed to a car. Similarly, the tagged documents 532B, 532G reflect information regarding a “U.S. President” without actually using that term. Further, documents which otherwise may be misconstrued as being associated with a U.S. president, such as document 502H, which refers to “Bush Furniture,” are eliminated as potential search results in response to a search for “U.S. President.” Moreover, the tagged documents 532 may be employed in subsequent search operations, thus reducing the need for repeated text analysis of the documents in response to subsequent searches using the same or similar terms.

Further, as a result of the document tagging function 530 (FIG. 5B) generating the tags for the tagged documents 532 (FIG. 10), subsequent instances of the text analysis function 520 (FIG. 5A) may be able to execute more quickly due to the added context information supplied by the tags, which remain available in the system. Thus, both the text analysis function 520 and the search function 540 may benefit from the use of the integration of these two functions 520, 540 in the method 500.

As discussed above, any and/or all of the document identification function 510, the text analysis function 520, and the document tagging function 530 may involve the tagging of one or more documents. Each of FIGS. 12A through 12C depicts a different method of tagging according to various embodiments. For example, FIG. 12A illustrates an example of “tagging by value” 1200A, in which a tag 1201A, including a tag value 1202, references a data object 1204 (e.g., a document) that the tag value 1202 describes. The tag value 1202 may be a simple character string that describes some aspect of the data object 1204, in one example. The tag value 1202 is not restricted by being associated with a particular value. Thus, the type of content that may be used for the tag value 1202 may be virtually unlimited. Tagging by value may be employed, for example, for the entity instance candidates 514 (FIG. 8), with the value indicating the one or more search categories that are relevant for the corresponding document.

FIG. 12B provides an example of “tagging by type” 1200B. In this example, a tag 1201B describing the data object 1204 includes a tag value 1205 that is associated with a particular tag type 1203. In some examples, the tag value 1205 may be restricted to one of a list of predetermined values specifically associated with the tag type 1203. For example, for a tag type 1203 of “size” associated with a data object representing a shirt, the possible tag values 1205 for this tag type 1203 may be limited to “small,” “medium,” “large,” and “extra-large.” A potential advantage of using tagging by type 1200B is that some semantic context is provided by restricting the number of options allowed for the tag value 1205 to facilitate the process of providing the tag 1201B. Similarly, the additional content provided by the tag type 1203 facilitates a more focused meaning for the associated tag value 1205, which provides for better results in some computer-related tasks, such as the searching described herein. In one example, tagging by value 1200A may be considered as a specific case of tagging by type 1200B, in which the tag type 1203 may be considered as “any” type, thus not restricting the associated tag value 1205 to a particular format or list of potential values. Tagging by type may be utilized, for example, with any and/or all of the entity instance candidates 514 (FIG. 8), the identified entity instances 524 (FIG. 9), and the tagged documents 532 (FIG. 10). In the examples of the identified entity instances 524 and the tagged documents 532, the tag type 1203 may refer to the search category, such as “Car” or “U.S. President,” while the associated tag value 1205 refers to the particular search term found in the document, such as “Chrysler” or “Bush.”

FIG. 12C illustrates an example of tagging by object 1200C. More specifically, a tag 1201C serves as a link between the first data object 1204 and a second data object 1206. As a result, the first data object 1204 is being tagged using the second data object 1206, and/or vice-versa. For example, the first data object 1204 may represent a particular product, while the second data object 1206 represents or contains a written product specification for the product. In one example, the tag 1201C may be a bidirectional (or undirected) link, so that a user or an application, having accessed one of the data objects 1204, 1206, may then access or reference the other of the data objects 1204, 1206 using the tag 1201C to navigate from one to the other. In other examples, the tag 1201C may be a unidirectional link, thus allowing navigation from only the first data object 1204 to the second data object 1206, or vice-versa. In yet other implementations, the tag 1201C may couple or link more than two data objects together, thus allowing navigation among any of the linked objects. Tagging by object may be employed for any and/or all of the entity instance candidates 514 (FIG. 8), the identified entity instances 524 (FIG. 9), and the tagged documents 532 (FIG. 10). For example, the identified entity instances 524 may each be represented as a separate data object, with a linking tag 1201C linking the data object with its associated analyzed document 522. In another example, a linking tag 1201C may link the search object types 504 (FIG. 7) with their associated documents at various phases of the method 500.

In some examples, each of the tags 1201A, 1201B, and 1201C may be implemented as a data object separate from the one or more data objects associated with the tag 1201, as shown in FIGS. 12A, 12B, and 12C, or the tags 1201 may be stored in at least one of the data objects 1204, 1206 corresponding to the tag 1201. Also, multiple tags 1201, possibly of different types, may be associated with one data object 1204 in at least some implementations.

Depending on the type of tagging to be performed, more than one of the tagging formats 1200A, 1200B, and 1200C may be employed for a particular tag. For example, tagging a document file represented by a data object 1204 with the name of an author can be accomplished by any of tagging by value 1200A (by using the name of the author as a tag value 1202), tagging by type 1200B (by using the name of the author as a tag value 1205, and a tag type 1203 of “author”), and tagging by object 1200C (by using a tag 1201C to link the data object 1204 for the document with a second data object 1206 representing the author). In some implementations, the tagging module 302 (FIG. 3) may determine which tagging format 1200A, 1200B, 1200C should be employed for a particular tagging instance, thus relieving the user from the burden of deciding which format 1200A, 1200B, 1200C to use.

In the implementations described above, the tagging data is generated automatically by a computer-implemented process, such as the tagging module 302 (FIG. 3) via performing text analysis on, or otherwise using, documents and other data objects, as discussed above. In other embodiments, a user may provide or specify at least portions of the tagging data mentioned above, such as by way of the user interface module 310 (FIG. 3). For example, the user may employ a user interface that provides input fields for the entry of text, such as the search categories and search terms referenced above. In other examples, the user interface may provide a predefined number of options for selection by the user for each type of tagging data, such as specific colors, sizes, shapes, viewer ratings, and the like. In another example, the user interface may allow the user to generate a tag by associating a document with another data object, such as the identified entity instances 524 noted above.

In at least some embodiments discussed herein, the integration of text analysis and search functionality by way of using data tags may increase the efficiency and accuracy of a search function, as well as possibly improve the text analysis function, as discussed above with respect to the examples of FIGS. 5A and 5B, and FIGS. 6 through 11. Subsequent search operations may also be facilitated by way of the results of the text analysis being stored from a prior search operation. In addition, relevant documents to be provided to a text analysis function may be determined by way of the automatic tagging of the documents. Moreover, entity instance candidates may be provided automatically to the text analysis function based on preceding searches involving the relevant documents. Thus, integration of text analysis and searching functions, in conjunction with the data tagging concepts discussed above, may enhance both functions symbiotically.

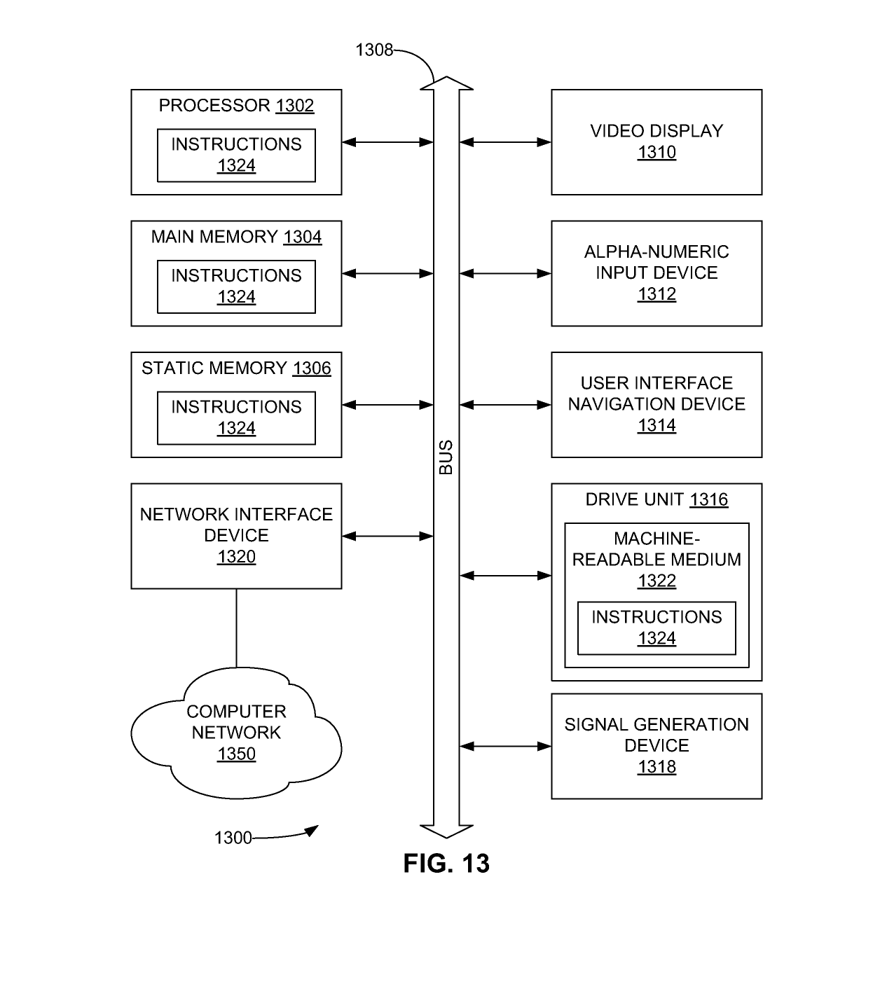

FIG. 13 depicts a block diagram of a machine in the example form of a processing system 1300 within which may be executed a set of instructions for causing the machine to perform any one or more of the methodologies discussed herein. In alternative embodiments, the machine operates as a standalone device or may be connected (for example, networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 1300 includes a processor 1302 (for example, a central processing unit (CPU), a graphics processing unit (GPU), or both), a main memory 1304 (for example, random access memory), and static memory 1306 (for example, static random-access memory), which communicate with each other via bus 1308. The processing system 1300 may further include video display unit 1310 (for example, a plasma display, a liquid crystal display (LCD), or a cathode ray tube (CRT)). The processing system 1300 also includes an alphanumeric input device 1312 (for example, a keyboard), a user interface (UI) navigation device 1314 (for example, a mouse), a disk drive unit 1316, a signal generation device 1318 (for example, a speaker), and a network interface device 1320.

The disk drive unit 1316 (a type of non-volatile memory storage) includes a machine-readable medium 1322 on which is stored one or more sets of data structures and instructions 1324 (for example, software) embodying or utilized by any one or more of the methodologies or functions described herein. The data structures and instructions 1324 may also reside, completely or at least partially, within the main memory 1304, the static memory 1306, and/or within the processor 1302 during execution thereof by processing system 1300, with the main memory 1304 and processor 1302 also constituting machine-readable, tangible media.

The data structures and instructions 1324 may further be transmitted or received over a computer network 1350 via network interface device 1320 utilizing any one of a number of well-known transfer protocols (for example, HyperText Transfer Protocol (HTTP)).

Certain embodiments are described herein as including logic or a number of components, modules, or mechanisms. Modules may constitute either software modules (for example, code embodied on a machine-readable medium or in a transmission signal) or hardware modules. A hardware module is a tangible unit capable of performing certain operations and may be configured or arranged in a certain manner. In example embodiments, one or more computer systems (for example, the processing system 1300) or one or more hardware modules of a computer system (for example, a processor 1302 or a group of processors) may be configured by software (for example, an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 1302 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (for example, hardwired) or temporarily configured (for example, programmed) to operate in a certain manner and/or to perform certain operations described herein. Considering embodiments in which hardware modules are temporarily configured (for example, programmed), each of the hardware modules need not be configured or instantiated at any one instance in time. For example, where the hardware modules include a general-purpose processor 1302 that is configured using software, the general-purpose processor 1302 may be configured as respective different hardware modules at different times. Software may accordingly configure a processor 1302, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 1302 that are temporarily configured (for example, by software) or permanently configured to perform the relevant operations. Whether temporarily or permanently configured, such processors 1302 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 1302 or processor-implemented modules. The performance of certain of the operations may be distributed among the one or more processors 1302, not only residing within a single machine but deployed across a number of machines. In some example embodiments, the processors 1302 may be located in a single location (for example, within a home environment, within an office environment, or as a server farm), while in other embodiments, the processors 1302 may be distributed across a number of locations.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

1. A method, comprising:
accessing search information indicating a search category and associated search terms, the search terms including examples and subcategories of the search category;
identifying those of a plurality of documents that include at least one of the search terms;
analyzing the identified documents to determine those of the identified documents that are logically associated with the search category; and
tagging each of the determined documents with the search category.

2. The method of claim 1, further comprising:
receiving a search request identifying the search category; and
returning me tagged documents m response to receiving the search request.

3. The method of claim 1, further comprising tagging each of the determined documents with those of the search terms included in the determined document being tagged.

4. The method of claim 1, the analyzing of the identified documents being performed using text analysis of the search terms in context with other content in the identified documents.

5. The method of claim 1, the search information, comprising related terms associated with each of the search terms of the search category, the analyzing of the identified documents being performed using the related terms.

6. The method of claim 1, the tagging of each of the determined documents comprising linking each of the determined documents with a tag type and a tag value associated with the tag type, the tag type comprising the search category, and the tag value comprising at least one of the search terms existing in the determined document being tagged.

7. The method of claim 1, the tagging of each of the determined documents comprising linking each of the determined documents with a data object identifying the search category.

8. The method of claim 7, the data object further identifying at least one of the search terms existing in the determined document being tagged.

9. The method of claim 1, further, comprising tagging the identified documents with the associated search terms, the analyzing of the identified documents being based at least in part on the tagging of the identified documents.

10. The method of claim 9, the tagging of the identified documents comprising linking each of the identified documents with a tag type and a tag value associated with the tag type, the tag type comprising the search category, and the tag value comprising at least one of the search terms existing in the identified document being tagged.

11. The method of claim 9, the tagging of each of the identified documents comprising linking each of the identified documents with a data object identifying the search category.

12. The method of claim 11, the data object further identifying at least one of the search terms existing in the identified document being tagged.

13. The method of claim 1, the identifying of at least one of the documents being responsive to the at least one of the documents being a new document.

14. The method of claim 1, the identifying of m least one of the documents being responsive to the at least one of the documents being changed.

15. The method of claim 1, the identifying of at least one of the documents being responsive to a previous search of the at least one of the documents.

16. A non-transitory computer-readable storage medium comprising instructions that, when executed by at least one processor of a machine, cause the machine to perform operations comprising:
accessing search information comprising search terms for a search category, the search terms including examples and subcategories of the search category;
identifying those of a plurality of documents that include at least one of the search terms;
analyzing the identified documents to determine those of the identified documents that are logically associated with the search category; and
tagging each of the determined documents with the search category.

17. The non-transitory computer-readable storage medium of claim 16, the operations further comprising:
receiving a search query identifying the search category; and
returning the tagged documents, in response to receiving the search query.

18. A system comprising:
at least one processor; and
modules comprising instructions that are executable by the at least one processor, the modules comprising;
a tagging module to access search information comprising search Terms for a search category, the search terms including examples and subcategories of the search category, and to identify those of a plurality of documents that include at least one of the search terms; and
a text analysis module to determine those of the identified documents that are logically associated with the search category;
the tagging module to tag each of the determined documents with the search category.

19. The system of claim 18, the tugging module to tag each of the determined documents with those of the search terms included in the determined documents.

20. The system of claim 18, further comprising a search module to receive a search request identifying the search category, and to return the tagged documents in response to the search request.
